(19) United States
(12) Patent Application Publication
(10) Pub. No.: US 2026/0081179 A1
(43) Pub. Date: Mar. 19, 2026

(54) COMPOSITE SUBSTRATE, SECONDARY BATTERY ELECTRODE INCLUDING SAME, AND ELECTRODE FABRICATION METHOD USING SAME

(71) Applicant: SAMSUNG SDI CO., LTD., Yongin-si (KR)

(72) Inventor: Jaehyeon YUN, Yongin-si (KR)

(21) Appl. No.: 19/216,933

(22) Filed: May 23, 2025

(30) Foreign Application Priority Data
Sep. 13, 2024 (KR) 10-2024-0126207

(51) Int. Cl. H01M 4/66; H01M 4/04; H01M 4/36

(52) U.S. Cl. CPC H01M 4/668; H01M 4/0404; H01M 4/0471; H01M 4/366

(57) ABSTRACT

A composite substrate includes a polymer layer extending in a first direction, and a first metal layer and a second metal layer on opposite sides of the polymer layer, respectively, the opposite sides of the polymer layer being spaced apart from each other in a second direction that is a thickness direction of the polymer layer, wherein each of the first metal layer and the second metal layer protrudes farther than an end of the polymer layer, and wherein a first protrusion protruding from the first metal layer and a second protrusion protruding from the second metal layer are joined to each other.

### CROSS REFERENCE TO RELATED APPLICATION

The present application claims priority to and the benefit of Korean Application No. 10-2024-0126207, filed on Sep. 13, 2024, in the Korean Intellectual Property Office, the entire disclosure of which is incorporated by reference herein.

### BACKGROUND

### 1. Field

The present disclosure relates to a composite substrate, a secondary battery electrode including the same, and an electrode fabrication method using the same.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The above information disclosed in this Background section is for enhancement of understanding of the background of the present disclosure, and therefore, it may contain information that does not constitute related (or prior) art.

### SUMMARY

According to some embodiments of the present disclosure, a composite substrate includes a polymer layer extending in a first direction; and a first metal layer and a second metal layer provided on opposite sides of the polymer layer, respectively, in a second direction that is a thickness direction of the polymer layer, wherein each of the first metal layer and the second metal layer protrudes further than an end of the polymer layer, and a first protrusion that is a protrusion of the first metal layer and a second protrusion that is a protrusion of the second metal layer are joined to each other.

According to some embodiments of the present disclosure, the polymer layer may be thermally contracted to be shorter than each of the first metal layer and the second metal layer in the first direction.

According to some embodiments of the present disclosure, the length of each of the first protrusion and the second protrusion may range from 5 mm to 7 mm.

According to some embodiments of the present disclosure, the polymer layer may include a thermoplastic material.

According to some embodiments of the present disclosure, an electrode includes a composite substrate having a polymer layer extending in a first direction and a first metal layer and a second metal layer provided on opposite sides of the polymer layer, respectively, in a second direction that is a thickness direction of the polymer layer; a first active material layer disposed on the first metal layer; and a second active material layer disposed on the second metal layer, wherein the polymer layer is thermally contracted to be shorter than each of the first metal layer and the second metal layer in the first direction.

According to some embodiments of the present disclosure, the composite substrate may include a first uncoated portion where the first active material layer is not provided to expose the first metal layer; and a second uncoated portion where the second active material layer is not provided to expose the second metal layer. The first uncoated portion and the second uncoated portion may be provided on a first end of the composite substrate in the first direction.

According to some embodiments of the present disclosure, the polymer layer may be thermally contracted by heat applied to the first uncoated portion and the second uncoated portion.

According to some embodiments of the present disclosure, as the polymer layer is thermally contracted, each of the first metal layer and the second metal layer may protrude further than an end of the polymer layer in the first direction, and a first protrusion that is a protrusion of the first metal layer and a second protrusion that is a protrusion of the second metal layer may be joined to each other.

According to some embodiments of the present disclosure, the length of the first protrusion in the first direction may range from 50% to 70% of the length of the first uncoated portion.

According to some embodiments of the present disclosure, each of the length of the first protrusion and the length of the second protrusion in the first direction may range from 5 mm to 7 mm.

According to some embodiments of the present disclosure, the polymer layer may include a thermoplastic material.

According to some embodiments of the present disclosure, an electrode fabrication method includes preparing a composite substrate including a polymer layer extending in a first direction and a first metal layer and a second metal layer disposed on opposite sides of the polymer layer in a second direction that is a thickness direction of the polymer layer; applying heat to the composite substrate to thermally contract the polymer layer so that the polymer layer is shorter than each of the first metal layer and the second metal layer in the first direction; and joining the first metal layer and the second metal layer.

According to some embodiments of the present disclosure, the electrode fabrication method may further include before thermally contracting the polymer layer, forming a first active material layer by applying an active material to the first metal layer of the composite substrate, and forming a second active material layer by applying an active material to the second metal layer of the composite substrate.

According to some embodiments of the present disclosure, the composite substrate may include a first uncoated portion where the active material is not provided to expose the first metal layer, and a second uncoated portion where the active material is not provided to expose the second metal layer. The first uncoated portion and the second uncoated portion may be provided on a first end of the composite substrate in the first direction.

According to some embodiments of the present disclosure, in the operation of thermally contracting the polymer layer, heat may be applied to an end of the composite substrate including the first uncoated portion and the second uncoated portion, and as the polymer layer is thermally contracted, each of the first metal layer and the second metal layer may protrude further than an end of the polymer layer.

According to some embodiments of the present disclosure, a length by which the first metal layer protrudes further than the end of the polymer layer may range from 50% to 70% of the length of the first uncoated portion.

According to some embodiments of the present disclosure, in the operation of joining the first metal layer and the second metal layer, a first protrusion that is a protrusion of the first metal layer and a second protrusion that is a protrusion of the second metal layer may be joined to each other.

According to some embodiments of the present disclosure, the first protrusion and the second protrusion may be welded together.

According to some embodiments of the present disclosure, each of the length of the first protrusion and the length of the second protrusion in the first direction may range from 5 mm to 7 mm.

According to some embodiments of the present disclosure, the electrode fabrication method may further include, after joining the first metal layer and the second metal layer, forming a substrate tab by blanking the first uncoated portion and the second uncoated portion.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 illustrates an example of a battery according to embodiments of the present disclosure;

FIG. 2 illustrates a cross-sectional view showing an example of a composite substrate according to embodiments of the present disclosure;

FIG. 3 illustrates a cross-sectional view showing an example of an electrode fabricated using a composite substrate according to embodiments of the present disclosure;

FIG. 4 illustrates a plan view showing an example of the electrode fabricated using the composite substrate according to embodiments of the present disclosure;

FIG. 5 illustrates an electrode fabrication method according to an embodiment of the present disclosure;

FIG. 6 illustrates an electrode fabrication method according to an embodiment of the present disclosure;

FIG. 7 illustrates an electrode fabrication method according to an embodiment of the present disclosure;

FIG. 8 illustrates an electrode fabrication method according to an embodiment of the present disclosure;

FIG. 9 illustrates a cross-sectional view showing an electrode according to a comparative example;

FIG. 10 illustrates a plan view showing the electrode according to the comparative example; and

FIG. 11 illustrates a flowchart showing an electrode fabrication method according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S. C. § 112(a) and 35 U.S. C. §132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In the present disclosure, the sizes and relative sizes of layers and regions shown in the drawings may be exaggerated for clarity of description. That is, the sizes shown in the drawings are for ease of understanding only and are not intended to be limiting. In addition, throughout the specification, like reference numerals refer to like components.

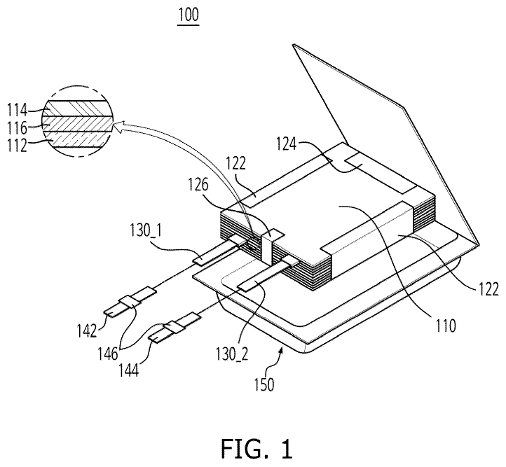

FIG. 1 illustrates an example of a battery 100 according to embodiments of the present disclosure. As shown in FIG. 1, the battery 100 may include a case 150 and an electrode assembly 110 disposed within the case 150.

The electrode assembly 110 may include a first electrode 112, a second electrode 114, and a separator 116. The electrode assembly 110 may have a stack type structure in which the first electrode 112 and the second electrode 114 each including a plurality of sheets are alternately stacked, with the separator 116, which is an insulator, provided therebetween. However, the electrode assembly 110 may have a winding type structure in which the first electrode 112 and the second electrode 114 are wound, with the separator 116 interposed therebetween. In another example, the electrode assembly 110 may be a Z-stack electrode assembly in which the first electrode 112 and the second electrode 114 are inserted on opposite sides of the separator 116 bent into a Z-stack.

The electrode assembly 110 may include one or more electrode assemblies 110 stacked and accommodated within the case 150 such that long sides thereof are adjacent to each other. The first electrode 112 of the electrode assembly 110 may act as a negative electrode, and the second electrode 114 may act as a positive electrode, e.g., the reverse is also possible.

The first electrode 112 may be formed by applying an active material, such as graphite or carbon, to a substrate and may include an uncoated portion, which is a region where the active material is not applied. A first substrate tab 130_1 may be connected to the uncoated portion of the first electrode 112. In some examples, the first substrate tab 130_1 may be formed by cutting to protrude from a first side portion in advance in a case where the first electrode 112 is fabricated, and may protrude further from the first side portion than the separator 116 without additional cutting.

The second electrode 114 may be formed by applying an active material, such as a transition metal oxide, to the substrate, and may include an uncoated portion, which is a region where the active material is not applied. A second substrate tab 130_2 may be connected to the uncoated portion of the second electrode 114. In some examples, the second substrate tab 130_2 may be formed by cutting to protrude from a second side portion in advance in a case where the second electrode 114 is fabricated, and may protrude further from the second side portion than the separator 116 without additional cutting.

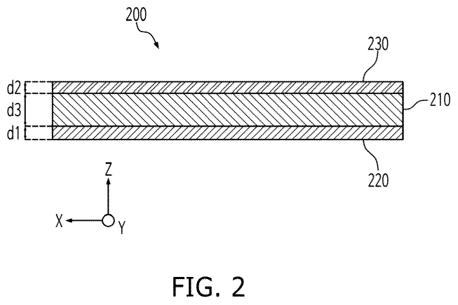

The substrate of each of the first electrode 112 and the second electrode 114 may include or be a composite substrate. For example, the substrate of each of the first electrode 112 and the second electrode 114 may include a polymer layer and a metal layer disposed on opposite sides of the polymer layer. Examples of composite substrates will be described later in more detail with reference to FIGS. 2 to 11.

The first substrate tab 130_1 may be a current flow path between the first electrode 112 and the first lead tab 142. The first lead tab 142 may have a tab film 146 attached thereto for insulation from the case 150. The second substrate tab 130_2 may be a current flow path between the second electrode 114 and the second lead tab 144. The second lead tab 144 may have the tab film 146 attached thereto for insulation from the case 150.

Protective tapes 122, 124, and 126 may be attached to the surface of the electrode assembly 110. For example, the protective tapes 122, 124, and 126 may be attached along the lateral perimeter of the electrode assembly 110. The protective tapes 122, 124, and 126 may align the electrode assembly 110 and protect the electrode assembly 110 from external impact.

The case 150 may form the overall contour of the battery 100 and provide a space in which the electrode assembly 110 is accommodated. The case 150 may be formed from a conductive metal, such as stainless use steel (SUS), aluminum, aluminum alloy, nickel-plated steel, or a laminated film or plastic from which a pouch is formed.

In FIG. 1, the case 150 is shown as a pouch-type case and the battery 100 is shown as a pouch-type battery, but the battery 100 may be any shape of battery, e.g., a prismatic battery, a cylindrical battery, a pouch battery, or the like. The battery 100 may be a type of secondary battery, e.g., a lithium battery, a sodium battery, or the like, or any battery capable of repeatedly providing electricity by charging and discharging.

FIG. 2 illustrates a cross-sectional view showing an example of a composite substrate 200 according to embodiments of the present disclosure.

In an embodiment, referring to FIG. 2, the composite substrate 200 may include a polymer layer 210 extending in a first direction (e.g., the X-axis direction) and metal layers 220 and 230 disposed on opposite sides of the polymer layer 210. For example, the first metal layer 220 may be disposed on a first side of the polymer layer 210 in a second direction (e.g., the Z-axis direction) that is a thickness direction of the polymer layer 210, and the second metal layer 230 may be disposed on a second side opposite the first side of the polymer layer 210. For example, as illustrated in FIG. 2, the polymer layer 210 may be directly between the first and second metal layers 220 and 230 in the Z-axis direction. For example, as illustrated in FIG. 2, the first and second metal layers 220 and 230 may completely cover the first and second sides of the polymer layer 210, respectively.

The polymer layer 210 may include a thermoplastic material. The polymer layer 210 may be in the form of a heat shrinkable film that contracts with heat at or above a predetermined temperature (e.g., 70° C. to 150° C.). The polymer layer 210 may include, e.g., materials such as polyethylene terephthalate (PET), polypropylene (PP), low-density polyethylene (LDPE), linear low-density polyethylene (LLDPE), and the like.

The first metal layer 220 and the second metal layer 230 may include a conductive material, e.g., the first metal layer 220 and the second metal layer 230 may include a same material or different materials from each other. For example, each of the first metal layer 220 and the second metal layer 230 may include a material such as copper, a copper alloy, nickel, a nickel alloy, or the like. In another example, each of the first metal layer 220 and the second metal layer 230 may include a material such as aluminum, an aluminum alloy, or the like. In yet another example, the first metal layer 220 may include a material such as copper, a copper alloy, nickel, a nickel alloy, or the like, and the second metal layer 230 may include a material such as aluminum, an aluminum alloy, or the like.

In an embodiment, the first metal layer 220 and the second metal layer 230 may be disposed on the polymer layer 210 in the form of a thin film. For example, the first metal layer 220 and the second metal layer 230 may be deposited on the polymer layer 210 by vapor deposition under vacuum, or may be coated on the surface of the polymer layer 210 by electroless plating or electroplating. For example, referring to FIG. 2, each of the thicknesses d1 and d2 of the first and second metal layers 220 and 230 along the Z-axis direction, respectively, may be smaller than the thickness d3 of the polymer layer 210.

For example, each of the thickness d1 of the first metal layer 220 and the thickness d2 of the second metal layer 230 may range from 1.0 μm to 3.0 μm, respectively. For example, the thickness d3 of the polymer layer 210 may range from 4.0 μm to 10.0 μm.

For example, the polymer layer 210 and the metal layers 220 and 230 may be reliably joined by vapor deposition, electroless plating or electroplating, e.g., as compared to a case where the polymer layer 210 and the metal layers 220 and 230 are joined by an adhesive or a binder. Accordingly, the polymer layer 210 and the metal layers 220 and 230 may be prevented from separating in the electrode fabrication process.

In addition, because the polymer layer 210 is formed within the composite substrate 200, the weight of the total composite substrate 200 itself (i.e., a combined weight of the polymer layer 210 with the metal layers 220 and 230) may be reduced (e.g., compared a substrate formed from a metal layer alone). In this case, the energy density of the cell may be improved as compared to using a substrate formed from a metal layer alone.

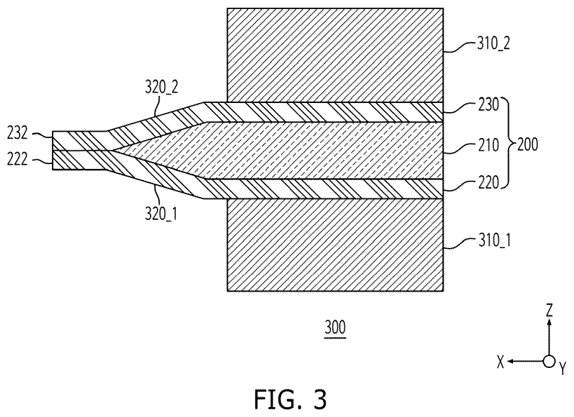

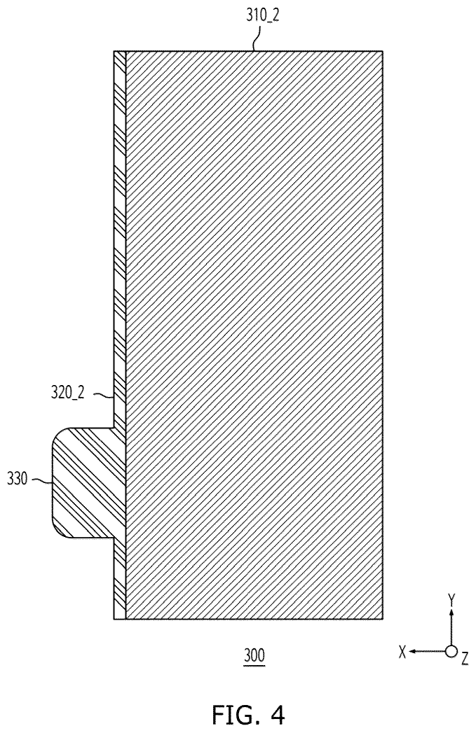

FIG. 3 illustrates a cross-sectional view showing an example of an electrode 300 fabricated using a composite substrate 200 according to embodiments of the present disclosure. FIG. 4 illustrates a plan view showing an example of the electrode 300 fabricated using the composite substrate 200 according to embodiments of the present disclosure.

Referring to FIG. 3, the electrode 300 may include the composite substrate 200 and active material layers 310_1 and 310_2 disposed on the composite substrate 200. The composite substrate 200 may include the polymer layer 210 extending in the first direction (e.g., the X-axis direction) and the first metal layer 220 and the second metal layer 230 disposed on opposite sides of the polymer layer 210 in the second direction (e.g., the Z-axis direction) that is the thickness direction of the polymer layer 210.

A first active material layer 310_1 and a second active material layer 310_2 may be disposed on the composite substrate 200. The first active material layer 310_1 and the second active material layer 310_2 may be formed by applying an active material to the composite substrate 200. For example, the first active material layer 310_1 may be disposed on the first metal layer 220 of the composite substrate 200, and the second active material layer 310_2 may be disposed on the second metal layer 230 of the composite substrate 200. For example, referring to FIG. 3, the first metal layer 220 may be between (e.g., directly between) the polymer layer 210 and the first active material layer 310_1, and the second metal layer 230 may be between (e.g., directly between) the polymer layer 210 and the second active material layer 310_2.

For example, each of the first metal layer 220 and the second metal layer 230 disposed on the opposite sides of the polymer layer 210 may include a material such as aluminum, an aluminum alloy, or the like. In this case, each of the first active material layer 310_1 and the second active material layer 310_2 disposed on the first metal layer 220 and the second metal layer 230, respectively, may include a positive electrode active material, and the electrode 300 may function as a positive electrode.

In another example, each of the first metal layer 220 and the second metal layer 230 disposed on the opposite sides of the polymer layer 210 may include a material such as silver copper, a copper alloy, nickel, a nickel alloy, or the like. In this case, each of the first active material layer 310_1 and the second active material layer 310_2 disposed on the first metal layer 220 and the second metal layer 230, respectively, may include a negative electrode active material, and the electrode 300 may function as a negative electrode.

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel oxide, lithium cobalt oxide, lithium manganese oxide, lithium iron phosphate compound, cobalt-free nickel-manganese oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹_{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}GgPO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel positive electrode active material may be capable of realizing high capacity and can be applied to a high-capacity, high-density rechargeable lithium battery.

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si negative electrode active material or a Sn negative electrode active material. The Si negative electrode active material may include silicon, a silicon-carbon composite, SiOₓ (0<x<2), a Si—Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn negative electrode active material may include Sn, SnO₂, a Sn alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si negative electrode active material or the Sn negative electrode active material may be used in combination with a carbon negative electrode active material.

As illustrated in FIG. 3, at least at a first end of the composite substrate 200 in the first direction (e.g., the X-axis direction), uncoated portions 320_1 and 320_2 may be formed to expose the substrate without an active material applied thereto. For example, the first active material layer 310_1 may not be disposed at the first end of the first metal layer 220 of the composite substrate 200, thereby forming the first uncoated portion 320_1 exposing the first metal layer 220. In addition, the second active material layer 310_2 may not be disposed at the first end of the second metal layer 230 of the composite substrate 200, thereby forming the second uncoated portion 320_2 exposing the second metal layer 230. In other words, the first and second uncoated portions 320_1 and 320_2 may be portions of the first and second metal layers 220 and 230, respectively, that are not coated with the first and second active material layers 310_1 and 310_2, respectively.

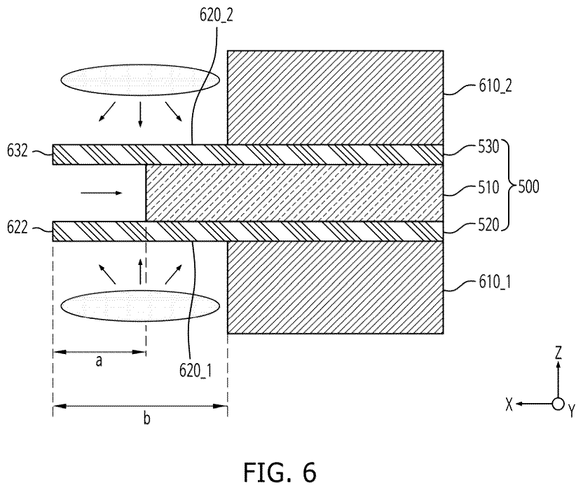

In an embodiment, the polymer layer 210 of the composite substrate 200 may be thermally contracted to be shorter than the first metal layer 220 and the second metal layer 230 in the first direction (i.e., the X-axis direction). For example, as an end of the composite substrate 200 including the first uncoated portion 320_1 and the second uncoated portion 320_2 is heated, the polymer layer 210 may be thermally contracted in the first direction (i.e., the X-axis direction). An example of the polymer layer 210 being thermally contracted will be described later in more detail with reference to FIG. 6.

As the polymer layer 210 is thermally contracted, the first metal layer 220 and the second metal layer 230 may protrude farther than the polymer layer 210 in the first direction (i.e., the X-axis direction). For example, the first metal layer 220 of the composite substrate 200 may include a first protrusion 222 protruding farther than an (e.g., beyond) end of the polymer layer 210 in the first direction (i.e., the X-axis direction). In addition, the second metallic layer 230 of the composite substrate 200 may include a second protrusion 232 protruding farther than (e.g., beyond) the end of the polymer layer 210 in the first direction (i.e., the X-axis direction).

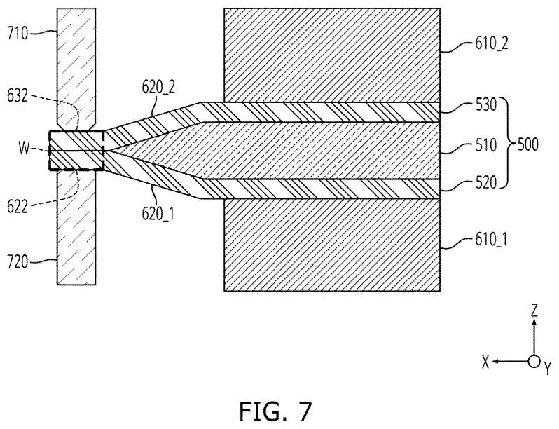

In an embodiment, the first metal layer 220 and the second metal layer 230 may be connected (e.g., directly connected) to each other. For example, the first protrusion 222 of the first metal layer 220 and the second protrusion 232 of the second metal layer 230 may be welded together (e.g., the first protrusion 222 of the first metal layer 220 and the second protrusion 232 of the second metal layer 230 may be directly welded to each other). As the first protrusion 222 and the second protrusion 232 are joined, the first metal layer 220 and the second metal layer 230 may be electrically connected to each other. An example of joining the first protrusion 222 and the second protrusion 232 will be described later in more detail with reference to FIG. 7.

Referring to FIG. 4, the electrode 300 may include a substrate tab 330. The substrate tab 330 may be formed by blanking the first uncoated portion 320_1 and the second uncoated portion 320_2 (e.g., leaving blank or uncoated portions of the first and second uncoated portion 320_1 and 320_2 to overlap and contact each other). The substrate tab 330 may protrude from a first side of the electrode 300 in the first direction (i.e., the X-axis direction).

In this configuration, as the polymer layer 210 is thermally contracted to cause the first metal layer 220 and the second metal layer 230 to protrude further than the polymer layer 210, a space may be provided for the first metal layer 220 and the second metal layer 230 to be welded together. Accordingly, the first metal layer 220 and the second metal layer 230 may be joined without connecting a separate conductive member or the like to the first metal layer 220 and the second metal layer 230.

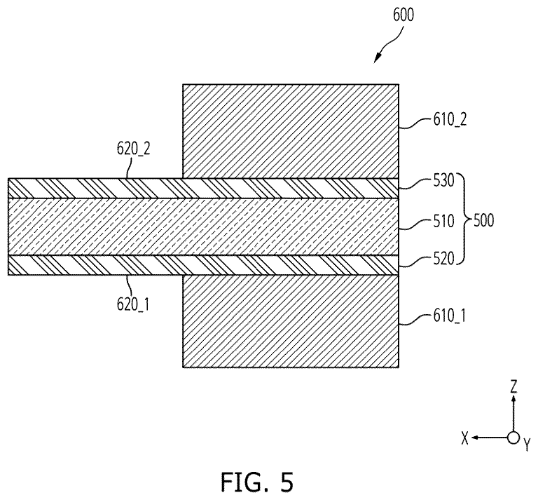

FIGS. 5 to 8 illustrate stages in an electrode fabrication method according to embodiments of the present disclosure.

Referring to FIG. 5, an electrode plate 600 may include a composite substrate 500 and active material layers 610_1 and 610_2 disposed on the composite substrate 500. The electrode plate 600 may be in a state where the active material has been applied to the composite substrate 500 and pressing and slitting processes have been completed.

In an embodiment, the composite substrate 500 may include a polymer layer 510 extending in the first direction (i.e., the X-axis direction) and a first metal layer 520 and a second metal layer 530 disposed on opposite sides of the polymer layer 510 in the second direction (i.e., the Z-axis direction) that is a thickness direction of the polymer layer 510. The polymer layer 510 may include a thermoplastic material.

In an embodiment, the first metal layer 520 and the second metal layer 530 may be formed on the surface of the polymer layer 510 by deposition or plating. Accordingly, in the first direction (i.e., the X-axis direction), the width of each of the first metal layer 520 and the second metal layer 530 may correspond to or be smaller than the width of the polymer layer 510.

The first active material layer 610_1 and the second active material layer 610_2 may be disposed on the composite substrate 500. For example, the first active material layer 610_1 may be disposed on the first metal layer 520 of the composite substrate 500, and the second active material layer 610_2 may be disposed on the second metal layer 530 of the composite substrate 500.

In an embodiment, uncoated portions 620_1 and 620_2 may be provided on at least a first end of the composite substrate 500. For example, the first active material layer 610_1 and the second active material layer 610_2 may be disposed on the central portion of the composite substrate 500 in the first direction (i.e., the X-axis direction), and at least the first end of the composite substrate 500 may have uncoated portions 620_1 and 620_2 where no active material is applied to expose the substrate (e.g., the composite substrate 500). The width of each of the uncoated portions 620_1 and 620_2 in the first direction (i.e., the X-axis direction) may range from 8 mm to 12 mm.

Referring to FIG. 6, heat may be applied to an end region of the electrode plate 600 including the first uncoated portion 620_1 and the second uncoated portion 620_2. For example, an induction heating coil may be spaced apart from and disposed to wrap around the end region of the electrode plate 600. Subsequently, the electrode plate 600 may be heated by heat emitted from the induction heating coil. For example, the electrode plate 600 may be heated at a temperature range of 100° C. to 150° C. for 10 seconds to 20 seconds. The temperature range and/or heating time in which the electrode plate is heated may be appropriately varied depending on the thickness of the electrode plate 600, the separation distance between the induction heating coil and the electrode plate 600, and the like. In an embodiment, the width of the region in which the electrode plate 600 is heated may correspond to the length b of the first uncoated portion 620_1 in the first direction (i.e., the X-axis direction).

The polymer layer 510 of the composite substrate 500 may be thermally contracted by heat applied to the end region of the electrode plate 600. The polymer layer 510 may be thermally contracted in the first direction (i.e., the X-axis direction) to be shorter than each of the first metal layer 520 and the second metal layer 530.

As the polymer layer 510 thermally contracts, the end of each of the first metal layer 520 and the second metal layer 530 may protrude farther than (e.g., beyond) the end of the polymer layer 510 in the first direction (i.e., the X-axis direction). For example, a first protrusion 622 where the first metal layer 520 protrudes farther than the polymer layer 510 may be provided on the end of the first metal layer 520, and a second protrusion 632 where the second metal layer 530 protrudes farther than the polymer layer 510 may be provided on the end of the second metal layer 530. For example, each of the first protrusion 622 and the second protrusion 632 may have a length of 5 mm to 7 mm.

In an embodiment, the length a of the first protrusion 622 in the first direction (i.e., the X-axis direction) may be 50% to 70% of the length b of the first uncoated portion 620_1. Similarly, the length of the second protrusion 632 in the first direction (i.e., the X-axis direction) may be 50% to 70% of the length of the second uncoated portion 620_2. For example, referring to FIG. 6, application of heat to the end region of the electrode plate 600 may cause the polymer layer 510 of the composite substrate 500 to contract by the length a to define the first and second protrusions 622 and 632 overhanging the polymer layer 510 by the length a.

Referring to FIG. 7, the first protrusion 622 of the first metal layer 520 and the second protrusion 632 of the second metal layer 530 may be joined to each other. The first protrusion 622 and the second protrusion 632 may be welded together. For example, the first protrusion 622 and the second protrusion 632 may be positioned to overlap (e.g., to vertically overlap in the Z-axis direction) each other on an anvil 720 and then welded together by ultrasonic energy applied by a welding horn 710.

In an embodiment, a weld W may be formed in a region where the first protrusion 622 and the second protrusion 632 overlap. The first metal layer 520 and the second metal layer 530 may be electrically connected to each other through the weld W. In this case, as the first protrusion 622 and the second protrusion 632 protrude to or beyond a predetermined length (e.g., 5 mm to 7 mm) by the thermal contraction of the polymer layer 510, the first protrusion 622 and the second protrusion 632 may be reliably welded together.

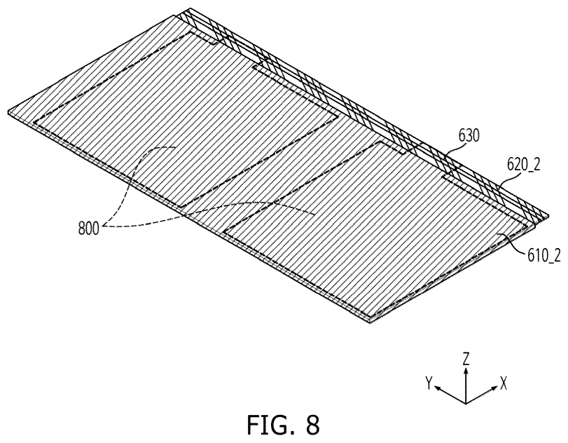

Referring to FIG. 8, the electrode plate 600 may undergo a notching process in which the electrode plate 600 is cut into the shape of an electrode 800. In this case, the first uncoated portion 620_1 and the second uncoated portion 620_2 may be blanked to form a substrate tab 630. The substrate tab 630 may protrude from a first side of the electrode 800 in the first direction (i.e., the X-axis direction).

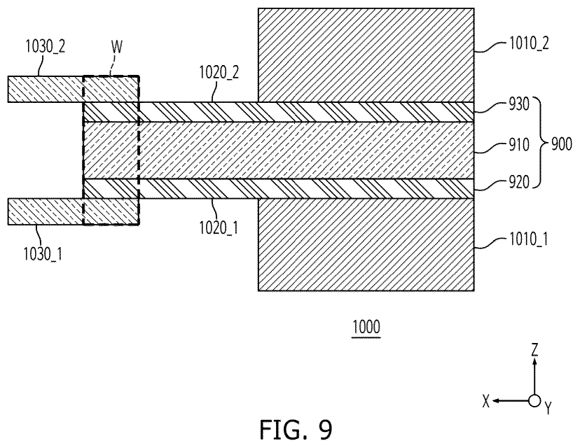

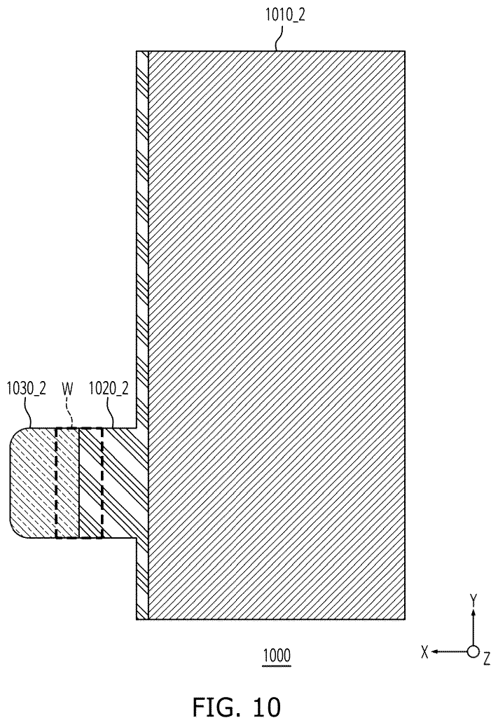

FIG. 9 illustrates a cross-sectional view showing an electrode 1000 according to a comparative example, and FIG. 10 illustrates a plan view showing the electrode 1000 according to the comparative example. The electrode 1000 according to the comparative example may include a composite substrate 900 and active material layers 1010_1 and 1010_2 disposed on the composite substrate 900. The composite substrate 900 may include a first metal layer 920 and a second metal layer 930 disposed on opposite sides of the polymer layer 910.

Referring to FIG. 9 and FIG. 10, when the length of the polymer layer 910 in the X-axis direction is the same as that of the first and second metals layers 920 and 930, i.e., when the polymer layer 910 is provided between the entire length of the first metal layer 920 and the second metal layer 930 of the composite substrate 900, the first metal layer 920 and the second metal layer 930 may not be electrically connected (e.g., the first metal layer 920 and the second metal layer 930 may be completely separated from each other by the polymer layer 910). In this case, current may be induced in only one of the two metal layers 920 and 930, thereby reducing the efficiency of the battery.

Accordingly, the structure in FIGS. 9-10 may require an additional process of connecting separate conductive members 1030_1 and 1030_2 to the first and second metal layers 920 and 930. For example, the conductive members 1030_1 and 1030_2 may be welded to the first and second metal layers 920 and 930, respectively. Thereafter, the first metal layer 920 and the second metal layer 930 may be electrically connected by joining the conductive member 1030_1 connected to the first metal layer 920 and the conductive member 1030_2 connected to the second metal layer 930. In this case, the thin thickness of the metal layers 920 and 930 may cause poor welding. In addition, the weld W where the first metal layer 920 and the second metal layer 930 and the conductive members 1030_1 and 1030_2 are welded may interfere with the polymer layer 910, thereby causing damage to the polymer layer 910.

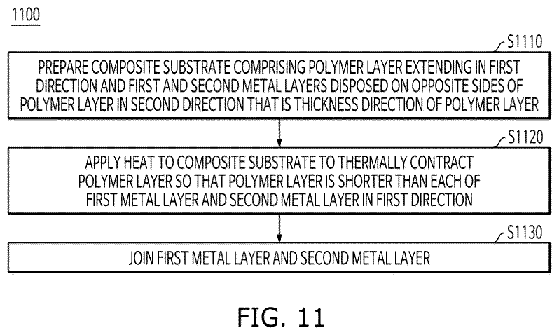

FIG. 11 illustrates a flowchart showing an electrode fabrication method 1100 according to embodiments of the present disclosure.

Referring to FIG. 11, the electrode fabrication method 1100 may begin with an operation S1110 of preparing a composite substrate including a polymer layer extending in a first direction and a first metal layer and a second metal layer disposed on opposite sides of the polymer layer in a second direction that is a thickness direction of the polymer layer. In addition, an active material may be applied to the first metal layer of the composite substrate to form a first active material layer. In addition, an active material may be applied to the second metal layer to form a second active material layer.

In this case, the composite substrate may include a first uncoated portion where no active material is applied to expose the first metal layer and a second uncoated portion where no active material is applied to expose the second metal layer is exposed. Herein, the first uncoated portion and the second uncoated portion may be formed on an end of the composite substrate in the first direction.

Subsequently, heat may be applied to the composite substrate to thermally contract the polymer layer so that the polymer layer is shorter than each of the first metal layer and the second metal layer in the first direction in S1120. For example, heat may be applied to the end of the composite substrate including the first uncoated portion and the second uncoated portion. In this case, as the polymer layer is thermally contracted, each of the first metal layer and the second metal layer may protrude farther than the end of the polymer layer.

In an embodiment, the length by which the first metal layer protrudes farther than the end of the polymer layer along the first direction may be, e.g., 50% to 70% of the length of the first uncoated portion. Similarly, the length by which the second metal layer protrudes farther than the end of the polymer layer in the first direction may be, e.g., 50% to 70% of the length of the second uncoated portion.

Thereafter, the first metal layer and the second metal layer may be joined in S1130. For example, the first protrusion formed by protruding the first metal layer and the second protrusion formed by protruding the second metal layer may be joined.

Herein, the first protrusion and the second protrusion may be welded together. In an embodiment, the length of each of the first protrusion in the first direction and the length of the second protrusion may be, e.g., 5 mm to 7 mm. In addition, after the first metal layer and the second metal layer are joined, the first uncoated portion and the second uncoated portion may be blanked to form a substrate tab.

The flowchart of FIG. 11 and the above description are merely illustrative of the present disclosure, but the scope of the present disclosure is not limited to the flowchart of FIG. 11 and the above description. For example, one or more operations of the flowchart and the above description may be added/changed/deleted, the order of one or more operations may be changed, and one or more operations may be performed substantially at the same time.

By way of summation and review, there has been an attempt to reduce the weight of secondary batteries used in portable information technology (IT) devices, automobiles, and the like by thinning materials of the secondary batteries (e.g., thinning materials of a substrate, a separator, and an exterior material applied to a secondary battery), by improving the properties of an active material to increase the energy density, and the like. However, application of these methods may not achieve the safety of a secondary battery.

In contrast, an aspect of the present disclosure provides a composite substrate, a secondary battery electrode including the same, and an electrode fabrication method using the same for solving the problems described above. That is, according to some embodiments of the present disclosure, because the polymer layer and the metal layer of the composite substrate are joined by a vapor deposition method, an electroless plating method, an electroplating method, or the like, the polymer layer and the metal layer may be stably joined. Accordingly, the polymer layer and the metal layer of the composite substrate can be prevented from separating in an electrode fabrication process.

According to some embodiments of the present disclosure, because the polymer layer is formed within the composite substrate, the weight of the substrate itself may be reduced. In this case, the energy density of the battery may be improved compared to using a substrate formed from a metal layer alone.

According to some embodiments of the present disclosure, as the polymer layer of the composite substrate is thermally contracted so that the first metal layer and the second metal layer disposed on opposite sides of the polymer layer protrude further than the polymer layer, a space may be provided for the first metal layer and the second metal layer to be welded together. Accordingly, the first metal layer and the second metal layer may be joined without connecting a separate conductive member or the like to the first metal layer and the second metal layer.

However, aspects and features of the present disclosure are not limited to those described above, and other aspects and features not mentioned will be clearly understood by a person skilled in the art from the detailed description, described above.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A composite substrate, comprising:
a polymer layer extending in a first direction; and
a first metal layer and a second metal layer on opposite sides of the polymer layer, respectively, the opposite sides of the polymer layer being spaced apart from each other in a second direction that is a thickness direction of the polymer layer,
wherein each of the first metal layer and the second metal layer protrudes farther than an end of the polymer layer, and
wherein a first protrusion protruding from the first metal layer and a second protrusion protruding from the second metal layer are joined to each other.

2. The composite substrate as claimed in claim 1, wherein the polymer layer is thermally contracted to be shorter than each of the first metal layer and the second metal layer in the first direction.

3. The composite substrate as claimed in claim 2, wherein a length of each of the first protrusion and the second protrusion is 5 mm to 7 mm.

4. The composite substrate as claimed in claim 1, wherein the polymer layer includes a thermoplastic material.

5. An electrode, comprising:
a composite substrate including a polymer layer extending in a first direction and a first metal layer and a second metal layer on opposite sides of the polymer layer, respectively, the opposite sides of the polymer layer being spaced apart from each other in a second direction that is a thickness direction of the polymer layer;
a first active material layer on the first metal layer; and
a second active material layer on the second metal layer,
wherein the polymer layer is thermally contracted to be shorter than each of the first metal layer and the second metal layer in the first direction.

6. The electrode as claimed in claim 5, wherein:
the composite substrate includes:
a first uncoated portion where the first active material layer is not provided, the first uncoated portion exposing the first metal layer; and
a second uncoated portion where the second active material layer is not provided, the second uncoated portion exposing the second metal layer, and
the first uncoated portion and the second uncoated portion are on a first end of the composite substrate in the first direction.

7. The electrode as claimed in claim 6, wherein the polymer layer is thermally contracted by heat applied to the first uncoated portion and the second uncoated portion.

8. The electrode as claimed in claim 6, wherein:
the polymer layer is shorter than each of the first metal layer and the second metal layer in the first direction, each of the first metal layer and the second metal layer protruding farther than an end of the polymer layer in the first direction, and
a first protrusion protruding from the first metal layer and a second protrusion protruding from the second metal layer are joined to each other.

9. The electrode as claimed in claim 8, wherein a length of the first protrusion in the first direction is 50% to 70% of a length of the first uncoated portion.

10. The electrode as claimed in claim 8, wherein each of a length of the first protrusion and a length of the second protrusion in the first direction is 5 mm to 7 mm.

11. The electrode as claimed in claim 5, wherein the polymer layer includes a thermoplastic material.

12. An electrode fabrication method, comprising:
preparing a composite substrate including a polymer layer extending in a first direction and a first metal layer and a second metal layer disposed on opposite sides of the polymer layer in a second direction that is a thickness direction of the polymer layer;
thermally contracting the polymer layer by applying heat to the composite substrate to so that the polymer layer is shorter than each of the first metal layer and the second metal layer in the first direction; and
joining the first metal layer and the second metal layer.

13. The electrode fabrication method as claimed in claim 12, further comprising, before thermally contracting the polymer layer:
forming a first active material layer by applying an active material to the first metal layer of the composite substrate; and
forming a second active material layer by applying an active material to the second metal layer of the composite substrate.

14. The electrode fabrication method as claimed in claim 13, wherein:
preparing the composite substrate includes:
forming a first uncoated portion where the active material is not provided to expose the first metal layer; and
forming a second uncoated portion where the active material is not provided to expose the second metal layer, and
the first uncoated portion and the second uncoated portion are provided on a first end of the composite substrate in the first direction.

15. The electrode fabrication method as claimed in claim 14, wherein:
thermally contracting the polymer layer includes applying heat to an end of the composite substrate including the first uncoated portion and the second uncoated portion, and
as the polymer layer is thermally contracted, each of the first metal layer and the second metal layer protrudes farther than an end of the polymer layer.

16. The electrode fabrication method as claimed in claim 15, wherein a length by which the first metal layer protrudes farther than the end of the polymer layer ranges from 50% to 70% of a length of the first uncoated portion.

17. The electrode fabrication method as claimed in claim 15, wherein joining the first metal layer and the second metal layer includes joining a first protrusion protruding from the first metal layer and a second protrusion protruding from the second metal layer.

18. The electrode fabrication method as claimed in claim 17, wherein joining the first protrusion and the second protrusion includes welding the first protrusion and the second protrusion.

19. The electrode fabrication method as claimed in claim 17, wherein each of a length of the first protrusion and a length of the second protrusion in the first direction ranges from 5 mm to 7 mm.

20. The electrode fabrication method as claimed in claim 14, further comprising, after joining the first metal layer and the second metal layer, forming a substrate tab by blanking the first uncoated portion and the second uncoated portion.
